(19) United States
(12) Patent Application Publication
(10) Pub. No.: US 2003/0115270 A1
(43) Pub. Date: Jun. 19, 2003

(54) High performance email relay system technical field

(76) Inventors: John Funk, (US); Bryan Costales, Boulder, CO (US)

Correspondence Address: GIBSON, DUNN & CRUTCHER LLP, Suite 4100, 1801 California Street, Denver, CO, 80202-2641, US

(21) Appl. No.: 09/881,658

(22) Filed: Jun. 15, 2001

(51) Int. Cl. G06F 15/16

(52) U.S. Cl. 709/206

(57) ABSTRACT

A method and system for identifying predetermined attributes of information destined for multiple recipients (e.g., emails) and selecting (or sequencing) the information for transmission from a single queue based on those attributes. The emails can be organized so that they can be more efficiently transmitted to their recipients based on the individual attributes of the emails.

### TECHNICAL FIELD

A method and system for establishing a sequence for the transmission of information to multiple destinations over a computer system network, such as an email relay system.

### BACKGROUND

I. Informational Messaging Background

The use of computer system networks to distribute information messages from a sender to one or more recipients is becoming more and more common. One of the most widely recognized and often used information distribution technologies today is electronic mail (“email”). While email is commonly used as a communications tool to send text messages from a sender to a recipient, it can also be used to send other types of information or messages such as numerical data, pictures, or computer files to be used with various software applications. As long as the sender's email device can be connected or linked to the recipient's email device (e.g., through a local network and/or over the internet), email can be electronically transmitted from the sender to the recipient.

Email is becoming more and more common place in the business world as well as for individual users at home. Business users use email to quickly communicate with or transmit information to co-workers, clients, customers, vendors and other persons who have access to email. Email is particularly advantageous and desirable because it does not depend upon the availability of the recipient at the time the email is transmitted and it can be stored conveniently for later retrieval and reference by the recipient. It is also particularly useful for sending the same information to multiple recipients. The number of email users has increased dramatically in the past seven years and the amount of use by individual users has also increased. This trend is expected to continue.

II. Email On A Local Network

Email is accessed by individual users through a technology device such as a computer terminal, wireless email device or a similar device that is equipped with the necessary hardware and software to use email applications. While many of the illustrations in this specification refer to a computer terminal as the technology device through which a user accesses email, this invention is not limited to use of email with computer terminals and can be used with virtually any messaging device or messaging technology.

Email technology devices are often connected to or can access a local network shared by many users. For example, many businesses have multiple computer terminals that are connected by a local network to a main computer system. Employees can use the various computer terminals to access information and files, such as email, from the main computer system.

A local network usually facilitates the nearly instantaneous transmission of emails between local network users. When an email is transmitted by a sending user to a receiving user, the email is normally sent to the main computer system for the local network. The computer system then notifies the receiving user that it has received an email for him or her. The receiving user can then retrieve a copy of the email on one of the computer terminals connected to the local network at his or her convenience. When an email is being transmitted to multiple receiving users, the computer system notifies each receiving user that it has an email for him or her so that each receiving user can retrieve a copy of the email.

III. Transferring Email Between Local Networks

The process of transferring information from a sender to a recipient is more complicated when the recipient is not part of the sending user's local network, but accesses email in a different way such as through a separate local network. In this case, the email must be transferred from the sender's local network to the recipient's local network before the recipient can access a copy of the email. To accomplish this, local networks use message transfer agents (“MTAs”) to send information to or receive information from other MTAs. Information can be transferred between two MTAs in several different ways such as over the internet, over telephone wires or through wireless communications connections.

The procedure for transferring information between local networks through MTAs is well known to one skilled in the art and will not be discussed in detail here. However, some aspects of the information transferring procedure are important to this invention. During this process, the MTA for the sender's local network (the Sending MTA”) must connect or link with the MTA for the recipient's local network (the “Receiving MTA”) before the email can be transmitted from the Sending MTA to the Receiving MTA. This is commonly done over the internet using a procedure such as simple mail transfer protocol (“SMTP”). The Sending MTA first notifies the Receiving MTA that it has information, such as an email, to transmit to the Receiving MTA and waits for the Receiving MTA to confirm that it is ready for the transmission. After the Sending MTA receives confirmation from the Receiving MTA, the information is transmitted by the Sending MTA to the Receiving MTA. The Receiving MTA can then forward the email to the appropriate place so that it can be accessed by the recipient. For example, it may be forwarded to the main computer system for the recipient's local network. The system will then notify the recipient that he or she has an email so that the recipient can retrieve a copy of the email.

IV. Limitations On The Transfer Process

The time it takes to complete this information transferring process can vary depending upon several factors. First, different MTAs are capable of sending and receiving information at different rates of speed. A more powerful MTA can receive information from a Sending MTA at a faster rate than a less powerful MTA can receive that information. Consequently, information can be transferred more quickly from a Sending MTA to a Receiving MTA that receives information at a faster rate than to a Receiving MTA that receives information at a slower rate. While the difference in the time it takes to transmit a single email may be minute, the difference in the time it takes to transmit large volumes of email can be significant. Therefore, more emails can be transmitted more quickly if the emails destined for fast Receiving MTAs are transmitted first.

Second, the amount of traffic being transmitted to the Receiving MTA at any given time can affect the amount of time required to complete a transmission. If only one Sending MTA is attempting to transmit information to a Receiving MTA, then the Receiving MTA can quickly confirm that it is ready for and accept the transmitted information from that single Sending MTA using a procedure such as SMTP. However, if more than one Sending MTA is attempting to transmit information to a Receiving MTA, then the Receiving MTA must confirm that it is ready for the transmitted information from each Sending MTA. This can result in a significant delay between the time any one Sending MTA requests a confirmation from a Receiving MTA and the time when that Sending MTA finally receives the requested confirmation. Therefore, it is advantageous to send multiple emails to a Receiving MTA at one time so that the Sending MTA does not need to repeat the confirmation process before each individual email is transmitted by a procedure such as SMTP, but can transmit multiple emails at one time using a procedure such as extended simple mail transfer protocol (“ESMTP”).

As the use of email has become more widespread, businesses are using emails to provide business services. For example, businesses are developing and employing methods for creating large numbers of emails destined for multiple recipients, such as customers or potential customers. Furthermore, automation advances now allow businesses to include personal information tailored for the individual recipients in these emails. These emails may be generated on a periodic (e.g., daily or weekly) basis, to regularly provide information to customers or potential customers.

The delivery of these large volumes of emails to multiple recipients has become increasingly challenging. Not only is it difficult to send these emails as quickly as possible, but the attributes of the individual emails can further complicate the process. For example, some of the information in these emails may be time sensitive, becoming stale in a short period of time. Information such as the value of a stock portfolio at the close of a business day is not very useful if the recipient does not receive the information until the close of the next business day. Likewise, box scores from sporting events are much less interesting to someone who receives them several days after the event. Therefore, it is important that emails containing time sensitive or high priority information be delivered to their recipients before the information becomes stale so the information is useful to the recipient.

V. The Traditional Sending Process

When emails have been created and are ready to be transmitted to their recipient, they have traditionally been saved to a local storage device to await transmission by a Sending MTA. The storage device acts as a queue or waiting area for these outgoing emails. When the Sending MTA is ready to send another email, the next email on the local storage device is retrieved by the Sending MTA for transmission. The Sending MTA will attempt to connect or link to the Receiving MTA for the intended recipient. Once the connection or link between the Sending MTA and the Receiving MTA has been made, the Sending MTA transmits the email to the Receiving MTA.

Traditionally, emails have been pushed from the local storage device or queue using the first-in first-out (“FIFO”) method. Under the FIFO method, the email that has been waiting in the queue for the longest amount of time is the next email transmitted by the Sending MTA. Therefore, if an email is placed in the queue when there are already fifty other emails waiting in the queue, then that email will not be transmitted by the Sending MTA until the Sending MTA has attempted to transmit the other fifty emails first.

The FIFO method has worked well for distributing smaller volumes of email in the past. The technology for transmitting the emails has been quick enough and the volume of emails being sent and received by MTAs small enough that emails were still transmitted fairly quickly, even during high use periods. Furthermore, if a single MTA was insufficient to send emails to or receive emails from other MTAs, additional MTAs could be added to the system to increase the capacity to send and receive emails or other information. By adding more Sending MTAs to the system, the queue is “drained” more quickly so that the emails are distributed more rapidly. However, regardless of the number of MTAs used in the system, emails are still pushed from the queue using a FIFO method.

The use of the FIFO method for sending emails can be problematic, especially when a sender is attempting to transmit large volumes of email. First, it can be expensive to purchase and operate additional Sending MTAs to handle the large volume of emails.

Second, while additional Sending MTAs will empty or drain the queue of emails more quickly during high-use periods when large volumes of emails are being transmitted, many of these Sending MTAs will sit idle or unused during low-use periods when few emails are being transmitted.

Third, if an email with important information is not sent quickly enough, the information contained in that email may become stale while the email is waiting in the queue for its turn to be transmitted to its intended recipient. Some have addressed this problem by adding a second queue dedicated to emails containing high priority information that must be delivered quickly. As long as the second queue remains short, the problem of information becoming stale in a single queue may be obviated. However, once again, this may not be an efficient use of resources as the Sending MTAs that are dedicated to transmitting emails from the second queue may remain idle for long periods of time waiting to transmit emails that must be delivered quickly.

Finally, the traditional sending process is delayed and further complicated when a MTA fails and goes down. For example, Sending MTAs can become jammed when too many emails destined for failed Receiving MTAs are moved aside to wait for further transmission attempts. Furthermore, when Sending MTAs fail or go down, additional hardware such as a load balancer must be used to fix the problem. In both cases, emails cannot be efficiently pushed through the queue and transmitted to their destination.

VI. The Need

Therefore, there exists a need to more efficiently distribute or transmit emails to multiple destinations from a single queue. It is therefore desirable to provide a system or method for processing or sequencing emails for transmission to one or more recipients that helps overcome the aforementioned problems. It is a purpose of this invention to provide such a system or method, whereby emails can be more efficiently transmitted from a single queue to multiple destinations based on the attributes of the individual emails.

### SUMMARY OF THE INVENTION

This invention is a method or system for processing and organizing informational messages, destined for multiple recipients, and sending the messages from a single queue based on predetermined attributes of the individual messages. While not limited to email technology, the invention can be used with the transmission of emails. An email processing system is used to identify predetermined attributes (e.g., the priority of the message being sent, the destination of the email, and the speed of the Receiving MTA) of the emails and organize the emails in files, or in a similar manner, based on those attributes. The email files can then be stored on a single shared storage device (i.e., a sending queue) to await transmission by a MTA. The files are stored on the shared storage device in such a way that the attributes of the emails in each file can be readily determined. When the Sending MTA is ready for its next transmission, it can determine which file of emails should be sent next based on the attributes of the emails in the file and the transmission criteria established by the sender. The files are then pulled from the shared storage device for transmission to their recipients based on the transmission criteria. The emails are thereby transmitted in the sequence determined by the user in the transmission criteria.

This method or system has many advantages over the traditional distribution method. First, important emails that should be transmitted before less important emails can be sent without first sending, or attempting to send all of the other emails that are already waiting in the sending queue. This is accomplished by identifying that attribute and setting the transmission criteria so that emails with important information will be pulled from the sending queue before the emails with less important information. Second, emails being transmitted to fast Receiving MTAs can be pulled from the queue first so that other emails are not unnecessarily delayed in being transmitted. This is accomplished by identifying that attribute and setting the transmission criteria so that emails destined to fast Receiving MTAs are pulled from the queue before emails destined for slow Receiving MTAs. This permits more emails to be distributed earlier, thereby reducing the back log in the sending queue. Third, this system permits tremendous flexibility. The user can identify emails by any number of attributes that are relevant to the delivery of those emails (e.g., priority of information, time in which information must be delivered, speed of the Receiving MTA, the language of the information, etc.). The system can then select (or sequence) emails from the sending queue based on any of these identified attributes as specified by the user.

### BRIEF DESCRIPTION OF THE DRAWINGS

The following drawings are incorporated into this specification and illustrate one or more embodiments of the invention.

FIG. 1 is a block diagram of an information distribution system for one embodiment of this invention.

FIG. 2 is a block diagram of the email processing system for the information distribution system in one embodiment of this invention.

FIG. 3 is a block diagram which shows how emails can be organized into files based on certain attributes of the emails in one embodiment of this invention.

FIGS. 4A and B are block diagrams which show representations of files saved on a shared storage device as a queue for transmission in one embodiment of this invention.

FIG. 5 is a flow chart showing one embodiment of this invention as a method by which emails are processed by the email processor and sent to the storage device.

FIG. 6 is a flow chart showing one embodiment of this invention as a method by which emails are selected from the storage device for transmission by the Sending MTA.

### DETAILED DESCRIPTION OF THE INVENTION

The following description of this invention is merely exemplary and does not describe each and every embodiment of the invention. It will be obvious to and can be appreciated by someone skilled in the art that the invention is not limited to the description in the specification, but necessarily includes other implementations and embodiments of the invention.

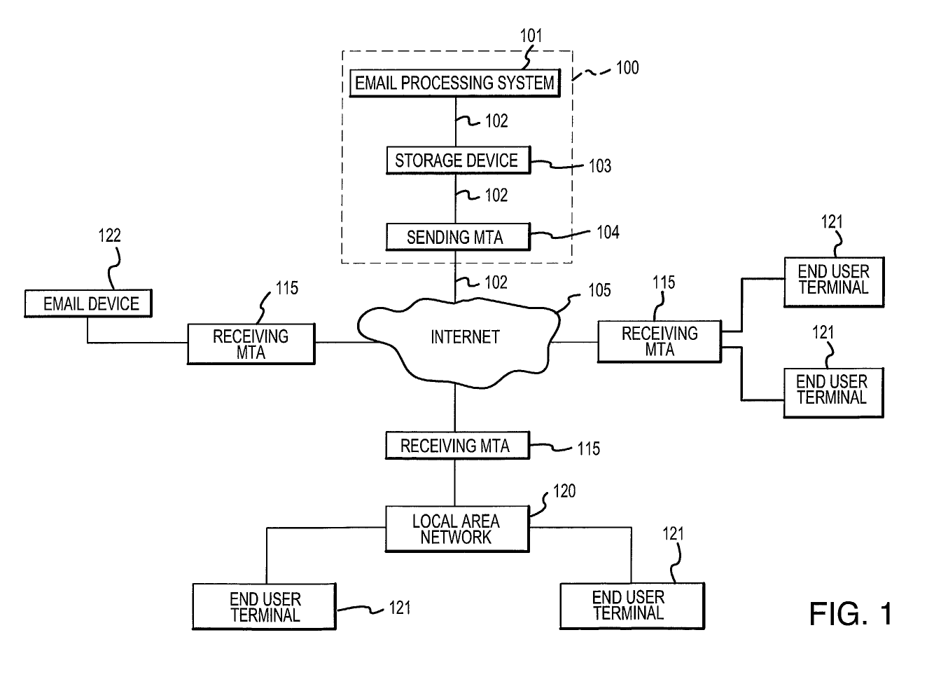

FIG. 1 is a block diagram of an information distribution system for one embodiment of this invention. In this embodiment, an email distribution center 100 processes and sends large volumes of email to multiple destinations over the Internet 105. The email distribution center 100 includes an email processing system 101, a shared storage device 103 and a MTA 104 for sending emails to their destinations. These parts of the distribution center 100 are linked by connections 102, which may be standard telephone line connections or other conventional computer connections. The email distribution center 100 is connected to the Internet 105 through the Sending MTA 104 by a connection 102.

As explained in more detail below, the email processing system 101 identifies certain attributes of outgoing emails that will be used to determine the sequence that the emails are transmitted. The email processing system 101 also organizes the emails by grouping emails with identical attributes into files before the files are sent to the shared storage device 103 to await transmission to recipients by the Sending MTA 104. This allows the Sending MTA 104 to transmit groups of emails at one time based on the attributes of the emails.

As the emails are being grouped or organized into files by the email processing system 101, the files are transferred to the storage device 103 when they contain a predetermined number of emails. The storage device 103 serves as a queue for email files that are ready to be transmitted. The files are stored on this storage device 103 until they are retrieved for transmission by the Sending MTA 104 based on a transmission criteria. This transmission criteria is used to select the sequence of email transmission based on the attributes of the emails.

The Sending MTA 104 takes files of emails from the storage device 103 and sends them to Receiving MTAs 115 over the Internet 105 so that the emails can be delivered to their intended recipients. Each email address is associated with a certain Receiving MTA 105, or in some cases, groups of Receiving MTAs (not pictured). Before an email file is transmitted, the Sending MTA 104 communicates with the Receiving MTA 115 over the Internet 105. The Sending MTA 104 initially contacts the Receiving MTA 115 and informs the Receiving MTA 115 that it has a transmission for the Receiving MTA 115. When the Receiving MTA 115 sends confirmation back to the Sending MTA 104 informing the Sending MTA 104 that it is ready for the transmission, the Sending MTA 104 sends the file of email messages to the Receiving MTA 115 over the Internet 105 using SMTP or ESMTP.

The Receiving MTA 115 is usually linked or connected to a local network 120 or email reading device 122 so that the email can be delivered from the Receiving MTA 115 to the intended recipient. If the Receiving MTA 115 is connected to a local area network 120, it can usually be accessed through an end user terminal 121. In some cases, the Receiving MTA 115 may be directly connected to one or more end user terminals 121. In other cases, the Receiving MTA 115 may send an email directly to an email reading device 122. However, it should be appreciated by one skilled in the art that this invention is not dependant on the manner in which the email is finally transmitted to the recipient.

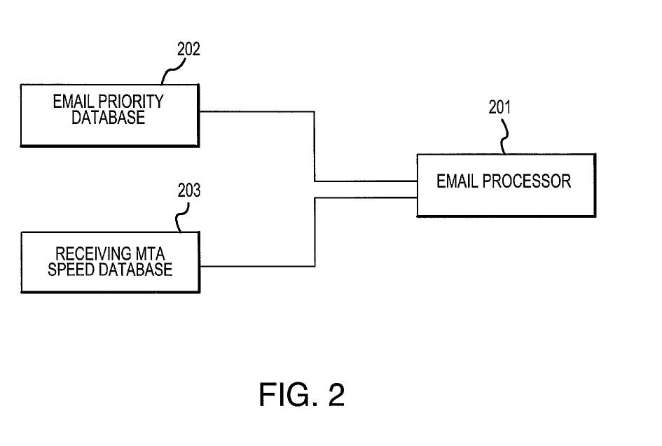

FIG. 2 is a block diagram of one embodiment of the email processing system 101. The email processing system 101 includes an email processor 201 that can access one or more databases of information that relate to the attributes of the email. As shown in this embodiment, the email processor 201 is connected to two databases: an email priority database 202 and a Receiving MTA speed database 203. The email processing system may include other databases that contain information about other attributes of the email such as the status of the Receiving MTA (e.g. is it up or down?), the location of the email in the queue, the format of the email message, and the MX host information.

An additional email attribute that is particularly useful to this invention is the “time to live” attribute, which is the last possible time at which the email must be transmitted to its recipient to have any value to its recipient. The transmission criteria can be set so that as the actual time gets closer to the time to live attribute, the implied priority of the email will increase. The email will therefore be pulled more quickly from the queue by the Sending MTA and transmitted before the time to live attribute is reached. If an email is not sent by the time defined in this attribute, the email may not be sent at all.

Each database 202-203 is connected to the email processor 201 so that the processor 201 can access information that is stored in the databases 202-203 when the processor 201 is determining the attributes for an email. For example, the email processing system 101 may be processing large volumes of email that contain information about the value of each recipient's stock portfolio and this information could be considered stale the next morning when the stock market opens. The information therefore needs to be delivered quickly and the sender may consider it a “high priority” email. The email priority database 202 may contain information that all emails with stock values are considered high priority and the processor 201 should assign a “high priority” attribute to that email.

Similarly, the email processor 201 can assign an attribute to the email based on information about the speed of the Receiving MTA 115 that is stored in the Receiving MTA speed database 203. For example, if the email is destined for a recipient at Yahoo.com, the processor 201 can retrieve information regarding the speed of the Receiving MTA at Yahoo.com from the Receiving MTA's speed database 203. The processor 201 should then assign an attribute to that email depending on whether it is a fast or slow Receiving MTA. Other databases containing information about other email attributes can be connected to the processor for use in processing emails before transmission.

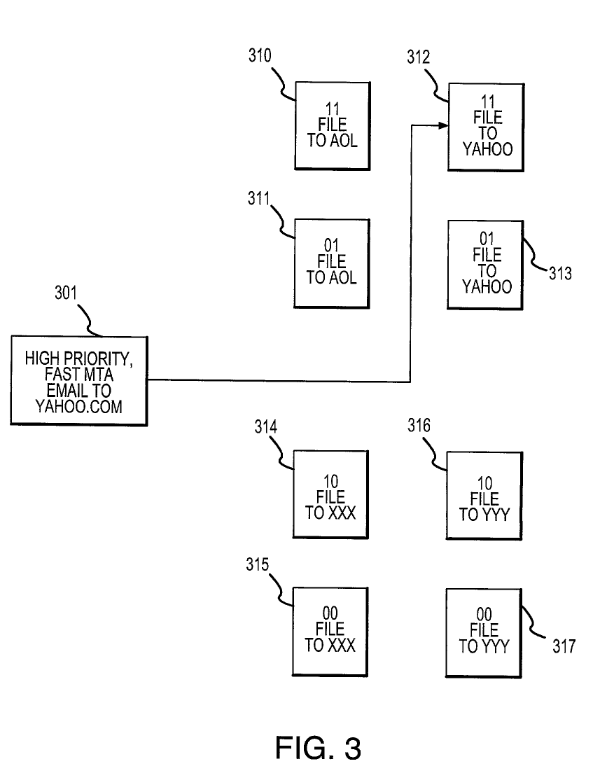

FIG. 3 is a block diagram which shows how the email processor organizes emails in files by attributes so that the attributes of the emails contained in each file are identical and readily identifiable. As described in more detail below, in this embodiment of the invention, the email processor is organizing emails based on three attributes: (1) the priority of information in the email; (2) the destination of the email; and (3) the speed of the Receiving MTA to which the email is destined. The priority of the information in the email is classified into two different categories: emails containing high priority information (high priority) and emails containing low priority information (low priority). Likewise, the speed of the Receiving MTA to which the email is destined is also classified into two categories: Receiving MTAs that receive transmissions quickly (fast) and Receiving MTAs that receive transmissions slowly (slow).

One way to make these email attributes readily identifiable after the emails are organized in files is to use the first two digits in the name of the file to identify the attributes of the emails contained in that file. For example, the first digit in the name of the file could be a “1” or a “0” depending on whether the information contained in the enclosed emails is high priority information or low priority information, respectively. Likewise, the second digit in the name of the file could be a “1” or an “0” depending on whether the Receiving MTA for the enclosed emails was fast or slow, respectively. Therefore, the four combinations of “1” and “0” found in the first two digits of the name of the file would identify two of the three attributes of the emails in the file. A file name beginning with “11” identifies the file as containing emails with high priority information that is destined to a fast Receiving MTA. A file name beginning with “10” identifies the file as containing emails with high priority information destined to a slow Receiving MTA. A file name beginning with “01” identifies the file as containing emails with low priority information destined to a fast Receiving MTA. Finally, a file name beginning with “00” identifies the file as containing emails with low priority information destined to a slow Receiving MTA. This naming convention allows the attributes of the emails enclosed in each file stored on the storage device to be determined by simply scanning the first two digits of the names of the files on the storage device.

The third attribute—the destination for the email—could also be coded on the name of the file so that the Sending MTA can easily identify where the file of emails is to be transmitted. If the destination of the emails is not included in the name of the file, the Sending MTA could determine the destination for all of the emails in the file by obtaining this information from the first email in the file. By placing emails that are being sent to the same destination into one file, all the emails in the file can be transmitted to the Receiving MTA at one time via ESMTP instead of waiting to receive confirmation from the Receiving MTA before sending each individual email.

As shown in FIG. 3, several files (files 310-317) for emails with various attributes have been opened by the email processor 201. There is a file for high priority emails being sent to AOL (file 310), a destination with a fast MTA. There is also a file for low priority emails being sent to AOL (file 311). Likewise, there is a folder for high priority emails being sent to Yahoo (file 312), a destination with a fast Receiving MTA, and low priority emails being sent to Yahoo (file 313). Similarly, there are files for high priority emails and low priority emails destined for XXX.com (files 314 and 315), a destination with a slow Receiving MTA. Finally, these are files for high priority emails and low priority emails destined to YYY.com (files 316 and 317), a destination with a slow Receiving MTA. Once the email processor 201 determines that the email 301 being processed contains high priority information destined for Yahoo.com, the processor will place the email 301 into the file for high priority emails destined for Yahoo (file 312).

The emails are organized accordingly by the email processor 201. As described in more detail below, the sender may choose to limit the number of emails placed in any one file. The files of emails are then saved to the storage device 103 to wait for delivery by the Sending MTA 104.

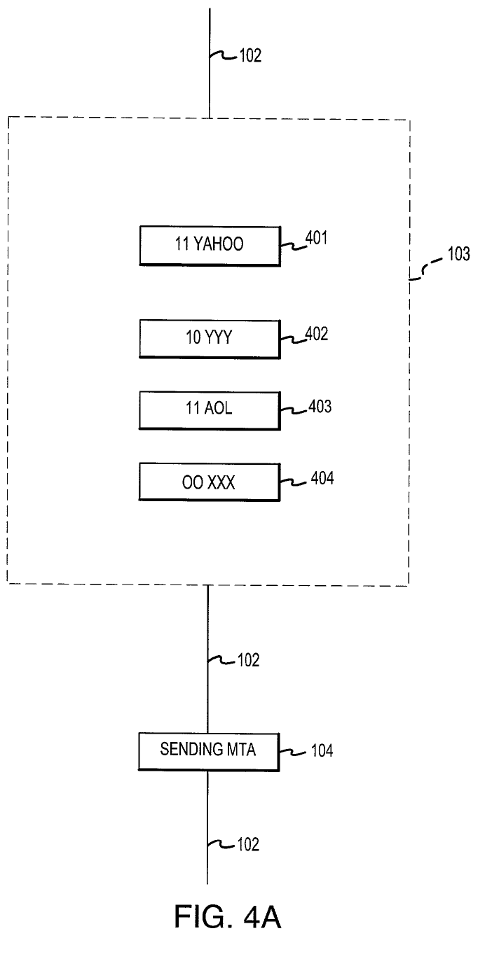

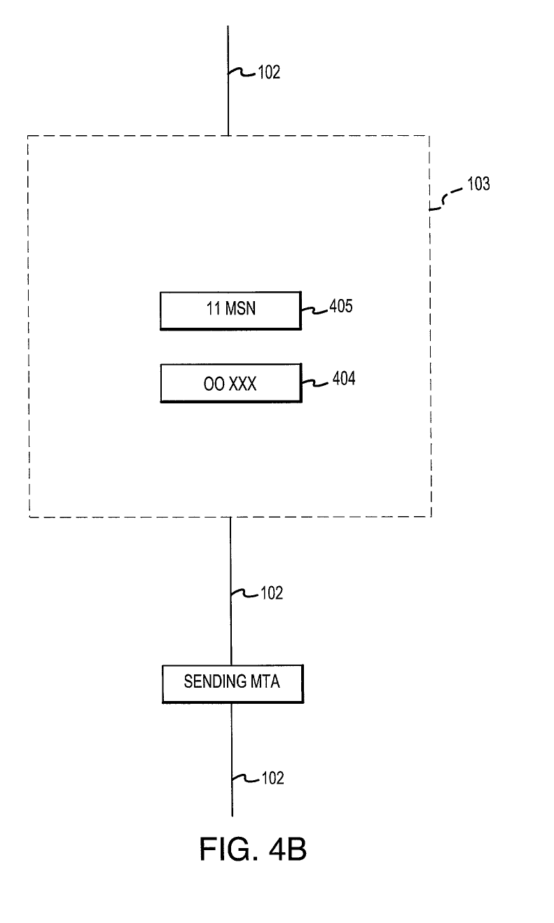

FIG. 4A is a block diagram showing files saved on the storage device 103 as a queue for transmission. As explained above, in this example the first two digits in the file name identify whether the emails in the file contain high priority or low priority information and whether the Receiving MTA for the destination is fast or slow. Here, four files of emails (files 401-404) are stored on the shared storage device 103, the queue, waiting to be transmitted by the Sending MTA 104: a file containing high priority emails destined to Yahoo, a destination with a fast MTA (file 401); a file containing high priority emails destined to YYY, a destination with a slow MTA (file 402); a file containing high priority emails destined to AOL, a destination with a fast MTA (file 403); and a file containing low priority emails destined to XXX, a destination with a slow MTA (file 404). The file at the bottom of the queue (file 404) has been waiting in the queue for the longest amount of time. The file second from the bottom of the queue (file 403) has been waiting in the queue the second most amount of time. The file second from the top of the queue (file 402) has been waiting in the queue the second least amount of time. The file on the top of the queue (file 401) has been waiting in the queue the least amount of time.

In this example, the transmission criteria for these files could be set by the sender so that emails are sent in the following order: (1) high priority emails to fast Receiving MTAs; (2) high priority emails to slow Receiving MTAs; (3) low priority emails to fast Receiving MTAs; and (4) low priority emails to slow Receiving MTAs. Furthermore, when determining between two or more files that fall into a single category, the transmission criteria could be set so that the file that has been waiting in the queue for the longest amount of time is sent before other files in the same category.

Based on this transmission criteria, the files shown in FIG. 4A would be sent by the Sending MTA 104 in the following order: (1) the file containing high priority emails destined to AOL, a destination with a fast MTA (file 403); (2) the file containing high priority emails destined to Yahoo, a destination with a fast MTA (file 401); the file containing high priority emails destined to YYY, a destination with a slow MTA (rile 402); and the file containing low priority emails destined to XXX, a destination with a slow MTA (file 404).

However, as shown in FIG. 4B, this order could be altered if another file of emails is added to the shared storage device 103 before the other files (files 401-404) have all been transmitted. For example, if another file containing high priority emails destined to MSN (file 405), a destination with a fast MTA, is added to the shared storage device 103 while the Sending MTA 104 is sending the file containing high priority emails destined to YYY, (file 402), then, based on the transmission criteria, the newly added file (file 405) will be transmitted by the Sending MTA 104 before the other remaining file (file 404) on the storage device.

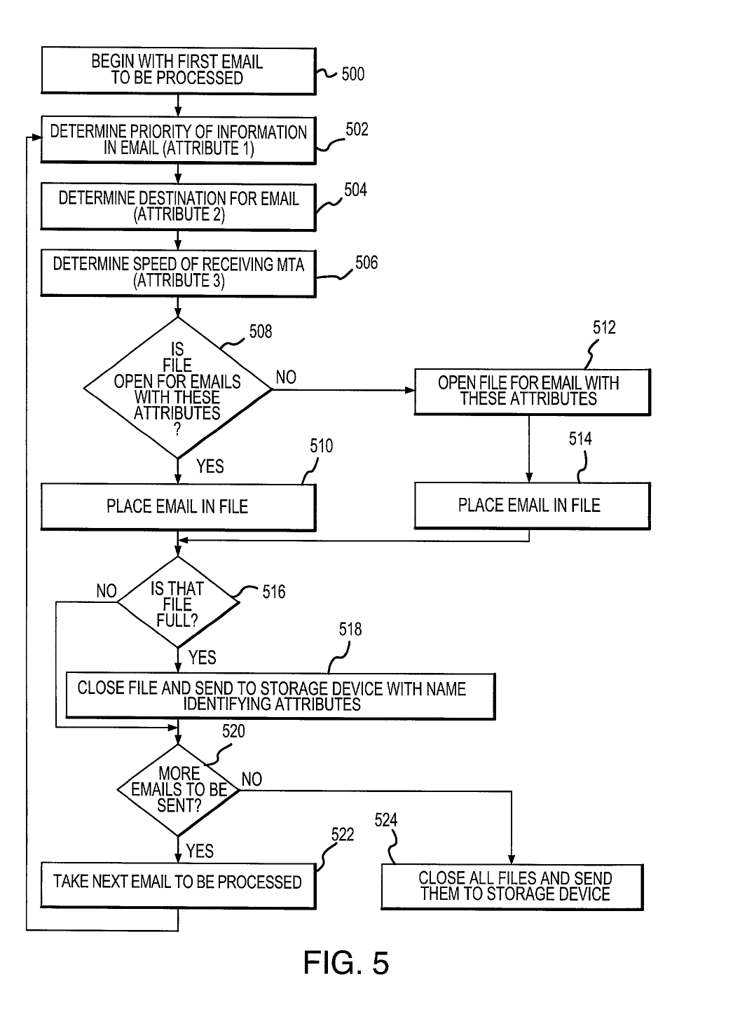

FIG. 5 is a flow chart showing a method by which emails can be processed and sent to the storage device 103 in the email distribution center 100. The process begins with the first email to be processed by the distribution center 100 (step 500). The system proceeds to determine the three attributes for the email being processed (steps 502, 504 and 506) and places the email in the file for emails with these three attributes (steps 508, 510, 512 and 514). While this embodiment uses three attributes, the invention can be used with more or fewer attributes.

The first email attribute is the priority of the information in the email, which is classified as either high priority or low priority (step 502). Information that must be delivered quickly (e.g., because the information is particularly important or may become stale after a short period of time) is identified as high priority. Conversely, information that does not need to be delivered quickly (e.g., because the message is not urgent or will not become stale in a short while) is identified as low priority. While this illustration only uses two categories for this attribute (high priority and low priority), additional categories for this attribute could also be used (e.g., medium, medium-high, medium-low).

The second and third email attributes are the destination for the email (step 504) and the speed of the Receiving MTA for that destination (step 506). The destination for the email can be determined by the email address for the recipient. By organizing outgoing emails into files according to their destination, these emails can be sent to that destination at one time. Therefore, the Sending MTA 104 does not have to reconnect and reconfirm the availability of the Receiving MTA 115 before it sends each individual email.

The Receiving MTAs 115 for these various destinations receive information at various speeds. Therefore, the third attribute of the email will identify whether the email is destined for a fast Receiving MTA or a slow Receiving MTA.

Still referring to FIG. 5, the processing system then places the email into a file containing emails with identical attributes (steps 508, 510, 512 and 514). Each file therefore contains emails with the same attributes (e.g., (1) high priority emails that are destined to Yahoo.com which has a fast Receiving MTA or (2) low priority emails that are destined to AOL.com which has a slow Receiving MTA).

A file is sent to the queue (e.g., saved to the shared storage device) when it contains the predetermined limit of emails or all of the emails have been processed. After an email is placed in a file, the system checks to see if that file is full (e.g., the predetermined limit has been reached) (step 516). The sender can determine if a predetermined limit will be used and, if so, the limit. This limit, if any, will probably depend upon the number of emails being processed and the number of attributes being used to organize the emails. For example, if the user is sending 100,000 emails sorted by two attributes, then it will probably be more efficient to place more emails in each file than it would if the user is sending 2,000 emails based on five attributes.

If the number of emails in the file has reached the predetermined limit, then the file is sent to the storage device and can be stored in a manner that identifies the attributes of the emails contained therein (step 518). If the file is not full, then the process will skip that step and check to see if there are additional emails to be processed for delivery (step 512). The process then repeats itself with the next email that is ready to be processed for delivery. This process continues until all the outgoing emails have been processed.

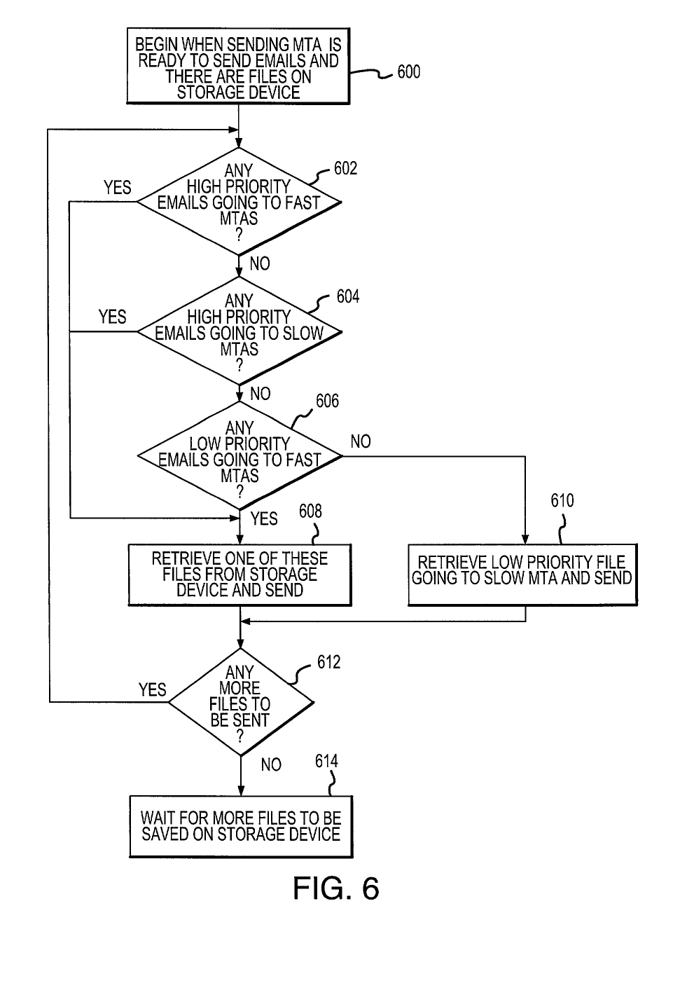

FIG. 6 is a flow chart showing a method by which emails are selected (or sequenced) from the storage device 103 (or queue) for transmission by the Sending MTA 104. The process begins when the Sending MTA 104 is ready to send more emails and there is at least one file of emails saved on the storage device 103, waiting to be transmitted (step 600). The files on the storage device are searched to see if there are any files that contain high priority emails going to fast MTAs (step 602), starting with the file that has been waiting on the queue for the most amount of time. In this case, this can quickly be done by scanning the names of the files stored on the storage device to see if any files have a name beginning with the digits “11”. The file names are scanned beginning with the file that has been in the queue the longest and ending with the file that most recently entered the queue so that the file containing high priority emails going to a fast MTA is transmitted first. If a file with high priority emails destined to a fast Receiving MTA is found, it is sent to the Sending MTA for transmission (step 608). If not, the storage device is again searched, starting with the file that has been in the queue the longest, for files that contain high priority emails going to slow MTAs (step 604). If a file containing emails with these attributes is found, it is sent to the Sending MTA for transmission (step 608). If not, the storage device is searched again for files containing low priority emails destined to fast Receiving MTAs (step 606). If such a file is found, it is sent to the Sending MTA for transmission (step 608). If not, the file that has been waiting in the queue the longest is sent to the Sending MTA for transmission (step 610).

Once that file has been transmitted by the Sending MTA 104, the storage device is checked to see if there are additional files stored on the storage device to be transmitted (step 612). If so, the process is repeated. If not, the process waits until another file of emails is sent to the storage device (step 614).

1. A method for processing two or more messages for transmission to one or more recipients, comprising:
identifying a set of one or more attributes of the messages;
establishing a transmission criteria for selecting the messages for transmission based on the attributes of the messages;
determining the set of attributes for each of the messages;
organizing the messages according to the set of attributes for each of the messages;
storing the organized messages on a shared storage device; and
selecting the organized messages from the shared storage device for transmission according to the criteria.

2. A method according the claim 1, in which the set of one or more attributes is selected from the group consisting of the destination of the message, the priority of the message, the estimated speed of the receiving message transfer agent, the status of the receiving message transfer agent, the format of the message, the time set of attributes is determined for the message, and the time at which the message must be transmitted to its recipient.

3. A method according the claim 1, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

4. A method according to claim 1, in which the messages are organized so that each message is placed into a file that contains messages with only the same set of attributes.

5. A method according to claim 4, in which each file contains no more than a predetermined number of messages.

6. A method according to claim 4, in which each file is stored on the shared storage device with a name that identifies one or more of the attributes for the messages in the file.

7. A system for processing two or more messages for transmission to one or more recipients comprised of:
a processor that determines one or more attributes for each of the messages and organizes the messages according to the attributes of each message;
a shared storage device that stores the organized messages until the messages are selected for transmission; and
a selector that selects the organized messages from the shared storage device for transmission according to a transmission criteria based on the attributes of the messages.

8. A system according to claim 7, in which the set of one or more attributes is selected from the group consisting of the destination of the message, the priority of the message, the estimated speed of the receiving message transfer agent, the status of the receiving message transfer agent, the format of the message, the time the set of attributes is determined for the message, and the time at which the message must be transmitted to its recipient.

9. A system according the claim 7, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

10. A system according to claim 7, in which the processor organizes the messages so that each message is placed into a file that contains messages with only the same set of attributes.

11. A system according to claim 10, in which each file contains no more than a predetermined number of messages.

12. A system according to claim 10, in which each file is stored on the shared storage device with a name that identifies one or more of the attributes for the messages in the file.

13. A method for organizing two or more messages for transmission to one or more recipients, comprising:
identifying a set of one or more attributes of the messages;
determining the attributes for each of the messages;
organizing the messages according to the attributes of each message; and
storing the organized messages on a shared storage device.

14. A method according the claim 13, in which the set of one or more attributes is selected from the group consisting of the destination of the message, the priority of the message, the estimated speed of the receiving message transfer agent, the status of the receiving message transfer agent, the format of the message, the time the set of attributes is determined for the message, and the time at which the message must be transmitted to its recipient.

15. A method according the claim 13, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

16. A method according to claim 13, in which the messages are organized so that each message is placed into a file that contains messages with only the same set of attributes.

17. A method according to claim 16, in which each file contains no more than a predetermined number of messages.

18. A method according to claim 16, in which each file is stored on the shared storage device with a name that identifies one or more of the attributes for the messages in the file.

19. A method for determining the sequence of two or more messages for transmission to one or more recipients, comprising:
establishing a transmission criteria for selecting the messages from a shared storage device for transmission based on a set of one or more attributes of the messages; and
selecting the organized messages from the shared storage device for transmission according to the criteria.

20. A method according the claim 19, in which the set of one or more attributes is selected from the group consisting of the destination of the message, the priority of the message, the estimated speed of the receiving message transfer agent, the status of the receiving message transfer agent, the format of the message, the time the set of attributes is determined for the message, and the time at which the message must be transmitted to its recipient.

21. A method according the claim 19, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

22. A method according to claim 19, in which the messages are organized so that each message is placed into a file that contains messages with only the same set of attributes.

23. A method according to claim 22, in which each file contains no more than a predetermined number of messages.

24. A method according to claim 22, in which each file is stored on the shared storage device with a name that identifies one or more of the attributes for the messages in the file.

25. A system for organizing two or more messages for transmission to one or more recipients, comprising:
a processor that determines one or more attributes for each of the messages and organizes the messages according to the attributes of each message; and
a shared storage device that stores the organized messages until the messages are selected for transmission.

26. A system according to claim 25, in which the set of one or more attributes is selected from the group consisting of the destination of the message, the priority of the message, the estimated speed of the receiving message transfer agent, the status of the receiving message transfer agent, the format of the message, the time the set of attributes is determined for the message, and the time at which the message must be transmitted to its recipient.

27. A system according the claim 25, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

28. A system according to claim 25, in which the processor organizes the messages so that each message is placed into a file that contains messages with only the same set of attributes.

29. A system according to claim 28, in which each file contains no more than a predetermined number of messages.

30. A system according to claim 28, in which each file is stored on the shared storage device with a name that identifies one or more of the attributes for the messages in the file.

31. A system for determining the sequence of two or more messages for transmission to one or more recipients, comprising:
a selector that selects the messages from a shared storage device for transmission according to a transmission criteria based on a set of one or more attributes of the messages.

32. A system according to claim 31, in which the set of one or more attributes is selected from the group consisting of the destination of the message, the priority of the message, the estimated speed of the receiving message transfer agent, the status of the receiving message transfer agent, the format of the message, the time the set of attributes is determined for the message, and the time at which the message must be transmitted to its recipient.

33. A system according the claim 31, in which the set of one or more attributes is selected from the group consisting of the priority of the message, the estimated speed of the receiving message transfer agent, the status of the receiving message transfer agent, the format of the message, the time set of attributes is determined for the message, and the time at which the message must be transmitted to its recipient.

34. A system according to claim 31, in which a processor first organizes the messages so that each message is placed into a file that contains messages with only the same set of attributes.

35. A system according to claim 34, in which each file contains no more than a predetermined number of messages.

36. A system according to claim 34, in which each file is stored on the shared storage device with a name that identifies one or more of the attributes for the messages in the file.
